(19) United States
(12) Patent Application Publication
(10) Pub. No.: US 2022/0261697 A1
(43) Pub. Date: Aug. 18, 2022

(54) FEDERATED LEARNING PLATFORM AND METHODS FOR USING SAME

(71) Applicant: Devron Corporation, New York, NY (US)

(72) Inventors: Kartik CHOPRA, New York, NY (US); Sidhartha ROY, New York, NY (US)

(73) Assignee: Devron Corporation, New York, NY (US)

(21) Appl. No.: 17/671,314

(22) Filed: Feb. 14, 2022

Related U.S. Application Data
(60) Provisional application No. 63/149,629, filed on Feb. 15, 2021.

(51) Int. Cl. G06N 20/20; H04L 9/00

(52) U.S. Cl. CPC G06N 20/20; H04L 9/008

(57) ABSTRACT

Systems and methods for federated machine learning are provided. A central system receives satellite analytics artifacts from a plurality of satellite site systems and generates a central machine learning model based on the satellite analytics artifacts. A plurality of federated machine learning epochs are executed. At each epoch, the central system transmitting the central machine learning model to the plurality of satellite site systems, and then receives in return, from each satellite site system, a respective set of satellite values for a set of weights of the model, wherein the satellite values are generated by the respective satellite site system based on a respective local dataset of the satellite site system. At each epoch, the central system then generates an updated version of the central machine learning model based on the satellite values received from the satellite site systems.

### CROSS-REFERENCE TO RELATED APPLICATIONS

This application claims the priority of U.S. Provisional Application No. 63/149,629, filed Feb. 15, 2021, the entire contents of which are incorporated herein by reference.

### FIELD

The present disclosure relates generally to federated machine learning, and more specifically to federated machine learning method using federated data analytics artifacts to build and train global machine learning models.

### BACKGROUND

Federated machine learning is a machine learning technique that enables the development of machine learning models based on training data that is not stored in a centralized location. Instead, the machine learning model is trained via a machine learning algorithm based on data that is distributed across multiple federated devices.

### SUMMARY

As stated above, federated machine learning allows for global machine learning models to be trained based on data that is distributed across multiple federated devices. Traditional federated learning platforms build a machine learning model for a specific output based on data inputs gathered from a plurality of federated locations. Thus, traditional systems require knowledge of the specific data inputs located in the federated locations. Accordingly, it can be impossible to build a central machine learning model using data stored in a private network where it is unknown what raw data is stored in the network. Thus, there is a need for systems and methods for building and training machine learning models with training data located at various federated locations without direct access to the data. Accordingly, disclosed herein are systems and methods that may address the above-identified need.

Disclosed herein are methods and systems for building and training a centralized machine learning model, based on data siloed across various different satellite sites, where data analytics artifacts generated based on the raw data stored at the various satellite sites are used to generate the model. Disclosed herein are methods for building and training a global machine learning model at a central authority. A central server located at the central authority can build a global machine learning model based on one or more of a plurality of satellite analytics artifacts received from a plurality of satellite site systems. The satellite analytics artifacts can be generated at the respective satellite sites, based on local data stored at a given satellite site, so that the actual raw data stored at the satellite is never exported to the central authority. The central server can be configured to train the global model by iteratively: sending instructions for each of the plurality of satellite site systems to perform a local update to generate a local satellite weight matrix, receiving and aggregating the local weight matrices received from each of the plurality of satellite site systems, updating the global machine learning model based on the aggregated local weight matrices, and generating new instructions for a successive round of training.

In some embodiments, an exemplary computer-implemented method for federated machine learning, as performed by a central system communicatively coupled to a plurality of satellite site systems, comprises: receiving a plurality of satellite analytics artifacts from respective satellite site systems of the plurality of satellite site systems; generating a central machine learning model based on one or more of the plurality of satellite analytics artifacts, wherein the central machine learning model comprises a set of central values for a set of weights; executing a federated machine learning epoch, comprising: transmitting the central machine learning model to the plurality of satellite site systems; receiving, at the central authority, from each of the respective satellite site systems, a respective set of one or more satellite values for the set of weights, wherein the set of one or more satellite values is generated by a respective satellite site system based on a respective local dataset of the respective satellite site system; and generating, based on the satellite values received from the satellite site systems, an updated version of the central machine learning model comprising updated central values for the set of weights.

In some embodiments, generating the updated version of the machine learning model comprises applying an averaging algorithm to the satellite values to generate a weight matrix comprising one or more average values for the set of weights.

In some embodiments, applying the averaging algorithm comprises applying one or more weighing factors for the respective satellite site systems.

In some embodiments, the method further comprises generating a machine learning pipeline based on one or more of the plurality of satellite analytics artifacts; and transmitting information regarding the machine learning pipeline to the plurality of satellite site systems.

In some embodiments, the machine learning pipeline comprises instructions for performing one or more of: a data preprocessing function, a statistics generation process, a data transformation process, a feature engineering process, a model training process, a model evaluation process, and a model storing process.

In some embodiments, the one or more satellite values is generated by the respective satellite site system by applying an optimization operation.

In some embodiments, the one or more satellite values are encrypted using a homomorphic scheme before transmission from the respective satellite site systems to the central authority.

In some embodiments, the plurality of satellite analytics artifacts comprise statistics and schema artifacts for each of the plurality of satellite site systems which are generated by a statistics generation pipeline.

In some embodiments, the respective satellite values are received as part of respective model artifacts received from each of the respective satellite site systems.

In some embodiments, the method further comprises one or more of: deploying the updated version of the central machine learning model to one or more selected from: one or more of the plurality of satellite site systems, a computer storage medium associated with the central authority, and an external system.

In some embodiments, an exemplary computing system for federated machine learning comprises: a central system communicatively coupled to a plurality of satellite site systems; and one or more processors coupled to one or more memory devices, wherein the one or more memory devices include instructions which when executed by the one or more processors cause the system to: receive a plurality of satellite analytics artifacts from respective satellite site systems of the plurality of satellite site systems; generate a central machine learning model based on one or more of the plurality of satellite analytics artifacts, wherein the central machine learning model comprises a set of central values for a set of weights; execute a federated machine learning epoch, comprising: transmitting the central machine learning model to the plurality of satellite site systems; receiving, at the central authority, from each of the respective satellite site systems, a respective set of one or more satellite values for the set of weights, wherein the set of one or more satellite values is generated by a respective satellite site system based on a respective local dataset of the respective satellite site system; and generating, based on the satellite values received from the satellite site systems, an updated version of the central machine learning model comprising updated central values for the set of weights.

In some embodiments, an exemplary computer-readable medium stores instructions that, when executed by a computing device, cause the device to: receive a plurality of satellite analytics artifacts from respective satellite site systems of the plurality of satellite site systems; generate a central machine learning model based on one or more of the plurality of satellite analytics artifacts, wherein the central machine learning model comprises a set of central values for a set of weights; execute a federated machine learning epoch, comprising: transmitting the central machine learning model to the plurality of satellite site systems; receiving, at the central authority, from each of the respective satellite site systems, a respective set of one or more satellite values for the set of weights, wherein the set of one or more satellite values is generated by a respective satellite site system based on a respective local dataset of the respective satellite site system; and generating, based on the satellite values received from the satellite site systems, an updated version of the central machine learning model comprising updated central values for the set of weights.

In some embodiments, an exemplary computer-implemented method for federated machine learning, as performed by a satellite site system communicatively coupled to a central system communicatively coupled to a plurality of respective satellite site systems, comprises: generating a set of satellite analytics artifacts based on a local data set stored at the satellite site system; transmitting the set of satellite analytics artifacts to the central system; receiving, from the central system, a central machine learning model, wherein the central machine learning model is generated based at least in part on the satellite analytics artifacts and wherein the central machine learning model comprises a set of central values for a set of weights; generating a set of satellite values for the set of weights, wherein the set of satellite values is generated based on the local data set; transmitting the set of satellite values to the central system; receiving, from the central system, an updated version of the central machine learning model comprising updated central values for the set of weights, wherein the updated version of the central machine learning model is generated by the central system at least in part based on the set of satellite values.

In some embodiments, generating the set of satellite analytics artifacts comprises extracting a set of schema and statistics from the local data set using a statistics generation pipeline that is transmitted to the plurality of satellite sites and is configured to compute the schema and statistics from the local data set and communicate the extracted schema and statistics to the central authority.

In some embodiments, generating the set of satellite values comprises applying a stochastic gradient descent.

In some embodiments, generating the set of satellite values comprises applying ADAM optimization.

In some embodiments, transmitting the set of satellite analytics artifacts to the central system comprises: applying a homomorphic encryption scheme to encrypt the satellite analytics artifacts; and transmitting the satellite analytics artifacts in encrypted form.

In some embodiments, transmitting the set of satellite values to the central system comprises: applying a homomorphic encryption scheme to encrypt the satellite values; and transmitting the satellite values in encrypted form.

In some embodiments, an exemplary computing system for federated machine learning comprises a satellite site system communicatively coupled to a central system communicatively coupled to a plurality of respective satellite site systems; and one or more processors coupled to one or more memory devices, wherein the one or more memory devices include instructions which when executed by the one or more processors cause the system to: generate a set of satellite analytics artifacts based on a local data set stored at the satellite site system; transmit the set of satellite analytics artifacts to the central system; receive, from the central system, a central machine learning model, wherein the central machine learning model is generated based at least in part on the satellite analytics artifacts and wherein the central machine learning model comprises a set of central values for a set of weights; generate a set of satellite values for the set of weights, wherein the set of satellite values is generated based on the local data set; transmit the set of satellite values to the central system; receive, from the central system, an updated version of the central machine learning model comprising updated central values for the set of weights, wherein the updated version of the central machine learning model is generated by the central system at least in part based on the set of satellite values.

In some embodiments, an exemplary computer-readable medium stores instructions that, when executed by a computing device, cause the device to: generate a set of satellite analytics artifacts based on a local data set stored at the satellite site system; transmit the set of satellite analytics artifacts to the central system; receive, from the central system, a central machine learning model, wherein the central machine learning model is generated based at least in part on the satellite analytics artifacts and wherein the central machine learning model comprises a set of central values for a set of weights; generate a set of satellite values for the set of weights, wherein the set of satellite values is generated based on the local data set; transmit the set of satellite values to the central system; receive, from the central system, an updated version of the central machine learning model comprising updated central values for the set of weights, wherein the updated version of the central machine learning model is generated by the central system at least in part based on the set of satellite values.

Additional advantages will be readily apparent to those skilled in the art from the following detailed description. The aspects and descriptions herein are to be regarded as illustrative in nature and not restrictive.

All publications, including patent documents, scientific articles and databases, referred to in this application are incorporated by reference in their entirety for all purposes to the same extent as if each individual publication were individually incorporated by reference. If a definition set forth herein is contrary to or otherwise inconsistent with a definition set forth in the patents, applications, published applications and other publications that are herein incorporated by reference, the definition set forth herein prevails over the definition that is incorporated herein by reference.

### BRIEF DESCRIPTION OF THE FIGURES

Various aspects of the disclosed methods and systems are set forth with particularity in the appended claims. A better understanding of the features and advantages of the disclosed methods and systems will be obtained by reference to the following detailed description of illustrative embodiments and the accompanying drawings, of which:

FIG. 1A depicts a system for federated machine learning, in accordance with some embodiments.

FIG. 1B depicts a method for building a global machine learning model using federated analytics artifacts, in accordance with some embodiments

FIG. 2 depicts a method for federated machine learning as performed by a central authority, in accordance with some embodiments.

FIG. 3 depicts a method for federated machine learning as performed by a satellite site, in accordance with some embodiments.

FIG. 4 depicts a method for federated machine learning, in accordance with some embodiments.

FIG. 5 depicts a system for collaborative federated machine learning, in accordance with some embodiments.

FIG. 6 depicts a computing device in accordance with some embodiments.

### DETAILED DESCRIPTION

Described herein are systems and methods for building and training a global machine learning model using federated analytics artifacts generated using raw data. A central authority (CA) CA computing system can build a global model using a plurality of data analytics artifacts received from each of a plurality of satellite systems. The plurality of satellite analytics artifacts can be generated at each respective satellite site system based on the raw data located at the satellite site. Beneficially, the CA computing system can build the global model using analytics artifacts generated using the raw data stored at each satellite site, such that the satellite sites do not need to exporting the raw data itself to the CA.

The CA computing system can train a global model developed based on satellite site analytics artifacts by iteratively sending instructions for each of the plurality of satellite site systems to perform a local update to generate a local satellite weight matrix based on the local data stored at that satellite site, receiving and aggregating the local weight matrices received from each of the plurality of satellite site systems, updating the global machine learning model, and generating new instructions for a successive round of training.

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are accorded the scope consistent with the claims.

### Model Building System

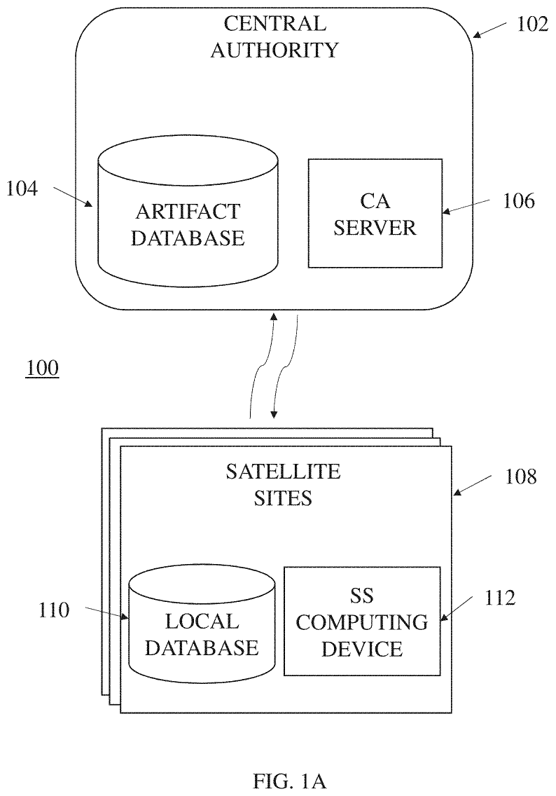

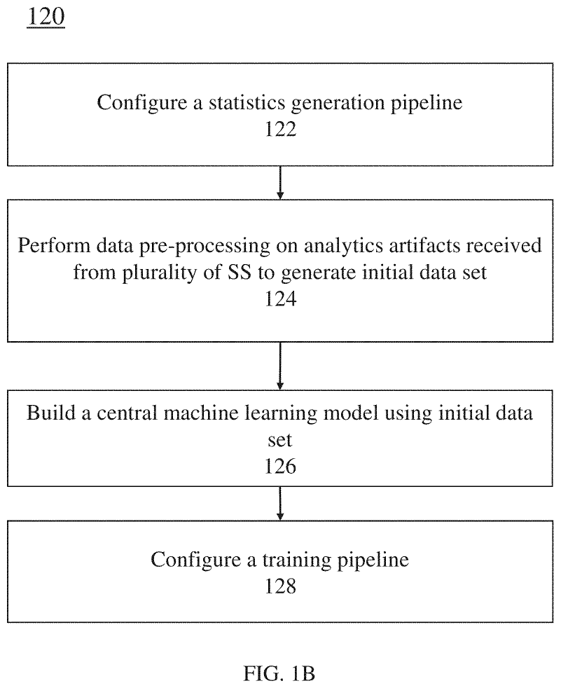

FIG. 1A illustrates a system 100 for federated machine learning, according to some embodiments. As shown, system 100 may include central authority 102 and a plurality of satellite sites 108. As described in detail herein, central authority 102 may be configured to communicate (e.g., by one or more wired or wireless network communication protocols and/or interface(s)) with the plurality of satellite sites 108 in order to exchange information to build and train a machine learning model.

Central authority 102 may include any computerized system configured to communicate with a plurality of satellite sites 108 and to execute one or more processes to build and train a machine learning model and/or extract analytics in conjunction with said satellite sites 108. Central authority 102 may include one or more processors, such as central authority server 106. Central authority 102 may include any suitable computer storage medium, such as artifact database 104, configured to store analytics artifacts usable to train and build machine learning models as described herein.

The plurality of satellite sites 108 each may include any computerized system configured to communicate with central authority 102 to build and train a machine learning in conjunction with central authority 102. As shown, a satellite site 108 may include a respective set of one or more processors, such as satellite site computing device 112. Additionally, a satellite site 108 may include a respective computer storage medium, such as local database 110, configured to store local data usable to train and build machine learning models as described herein.

In FIG. 1A, detailed components of one exemplary satellite site 108 are shown, though it should be understood that any one or more of the plurality of satellite sites 108 may include same or similar corresponding components. In some embodiments, system 100 may be configured such that a satellite site 108 can be connected to and disconnected from central authority 102, for example in response to a user instruction or automatically in response to one or more trigger conditions, together with or independently from one or more of the other satellite sites 108.

In some embodiments, satellite sites 108 can be distributed across multiple geographic locations, multiple different organizations, and/or multiple departments within the same organization. In some embodiments, satellite sites may be located geographically proximate to one another (including, even, by being provided as a part of the same computer system) while being communicatively demarcated from one another (e.g., such that they cannot communicate directly with one another). In some embodiments, SS computing device 112 may include a cloud-based server and/or a bare-metal server.

### Model Training Equations

In some embodiments, system 100 may be configured to build and train a machine learning model by establishing and then updating a central (e.g., global) weight matrix that includes weights that are updated based on weight values received from each satellite site. The weight values may be aggregated and used to generate central values for a global network model that is stored at central authority 102. System 100 can train a machine learning model in a series of iterative federated epochs, wherein each federated epoch includes operations performed by central authority 102 and by a plurality of satellite sites. (It should be noted that within each federated epoch, each satellite site may execute one or more respective satellite epochs, wherein each satellite epoch may include a round of model training performed locally at the satellite site.) During each federated epoch, system 100 can be configured to generate an updated satellite weight matrix at each satellite site using data stored in a local database 110. System 100 can then receive and aggregate each satellite weight matrix into an updated global weight matrix at the central authority 102. System 100 can develop an updated global network model using the updated global weight matrix, wherein the update to the global network model is indicative of the just-executed federated epoch.

In some embodiments, the global network model comprises a global weight matrix Wₑ^{g}∈R^{m×n}, where Wₑ^{g} denotes the weight parameters of the global machine learning model to be trained on the data located across multiple satellites. In the global network model, W indicates a real number weight matrix with m×n as the dimension, g indicates a global model, and e indicates a federated epoch number. The global weight matrix may be initialized with a random distribution or other suitable distributions, or it may include initial weight values associated with some pre-trained model. The global network model could be a single statistical model or network or a combination of traditional statistical models or deep neural networks such as feedforward, convolutional, or recurrent networks.

According to one or more embodiments, the system can include multiple satellites. The satellite network model at each satellite site can comprise a satellite weight matrix Wₑ^{k}∈R^{m×n}, where k can be an integer ranging from 1 to S for a system with S number of satellites, and e indicates the federated epoch number. The satellite weight matrix Wₑ^{k} for a specific federated epoch can be computed by applying a gradient update based on various factors. Such factors can include the number of data points at each satellite location and/or the information content of the data at each satellite location.

The central federated epoch e represents which round of training the global network model comprising Wₑ^{g} is based on. For example, before model training begins, e=0. Thus, prior to training a global network model for a system containing S number of satellite sites, the global weight matrix for the global network model can be expressed as W₀^{g}. At federated epoch 0 the global model is communicated to all the satellites, and therefore the weight matrices for each of the satellites at federated epoch 0 are initially equivalent to the global weight matrix for the global network model, as shown:

W₀¹,W₀², . . . ,W₀^{S}=W₀^{g}

After a single round of training, the local satellite weight matrix at each satellite, Wₑ^{k}, can then be expressed as:

Wₑ^{k}=Wₑ^{g}−α*Gₑ^{k}

where Gₑ^{k} is the gradient update for satellite k, which is added to or subtracted from the global weight matrix for the global network model for a given federated epoch; Wₑ^{g} is the global weight matrix for the global network model for that federated epoch; and a is the learning rate. The learning rate a is a hyperparameter that may be set in accordance with a user input, system settings, and/or may be dynamically/programmatically adjusted and set. The gradient update Gₑ^{k} may, in one or more embodiments, be computed using backward propagation for neural networks. For example, after a single round of training is completed and e=1, if the gradient update for satellite number 1 is G₁¹ computed using backward propagation then the local satellite weight matrix can be expressed as W₁¹=W₁^{g}−α*G₁¹.

According to some embodiments, the local gradient update for each satellite Gₑ^{k} can be generated by applying various optimization methods including but not limited to stochastic gradient descent, ADAM, or Root Mean Squared Propagation (RMSProp). The one or more local satellite values for the satellite weight matrix may be determined based on accuracy metrics. In some embodiments, the system apply a predefined or dynamically determined accuracy threshold to select accurate values. In some embodiments, the system may select a predefined or dynamically determined number of most accurate values from those available.

A satellite site can be configured, for example, to select values for the satellite weight matrix by determining which values yield the highest accuracy metrics based on specific hyperparameters.

According to some embodiments, the satellite weight matrices (and/or values for said matrices) can be encrypted before being transmitted from each satellite site to the central authority. System 100 can be configured to perform machine learning computations on encrypted data without requiring the data to be decrypted before any computations. System 100 can also filter out sensitive data and export only encrypted model updates, logs, or other non-sensitive information from the local data set at each satellite location. In some embodiments, the satellite weight matrices (and/or values for said matrices) can be encrypted using secure multi-party computation (SMPC). System 100 can be configured to perform computations using inputs that are kept private.

In some embodiments, the satellite weight matrices (and/or values for said matrices) can be encrypted using homomorphic encryption (HE) where the data contained in each satellite weight matrix (and/or values for said matrix) is secured by a secret key. According to some embodiments, data protected by homomorphic encryption will remain encrypted until the owner of the secret key decrypts the data. A homomorphic scheme that can be utilized to encrypt the satellite weight matrix (and/or values for said matrix) may be expressed as:

Cₑ^{k}←Enc(K_{pub},Wₑ^{k})

where K_{pub} is the public key available to all of the satellite sites, and Cₑ^{k}∈ [symbol] . That is, Cₑ^{k} for a given satellite number represents a number in the complex set of numbers, [symbol] , which contains the encrypted satellite weight matrices (and/or values for said matrices). The encrypted satellite weight matrices (and/or encrypted values for said matrices) belong to cipher text space [symbol] , whereas the satellite weight matrices (and/or values for said matrices) belong to the message space, Wₑ^{k}∈M, such that M⊂R. Enc( ) is the encryption function.

The global weight matrix Wₑ^{g} can be expressed as:

$${W}_{e}^{g} = \frac{1}{S} [ D e c ( {K}_{s e c} , {C}_{e}^{1} ⊕ {C}_{e}^{2} ⊕ … ⊕ {C}_{e}^{S} ) ]$$

where Dec is the decryption function and K_{sec} is the secret key. The operator ⊗ in the cipher text space [symbol] satisfies multiplication in the message space M and the operator ⊕ in the cipher text space [symbol] satisfies addition in the message space M.

In some embodiments, system 100 can apply a weighted averaging operation using a weighing factor, w^{k} where k corresponds to the particular satellite. The weighing factor can be applied during the weighted averaging operation applied to the satellite weight matrices (and/or values for said matrices). The weighing factor can be a system input, or may be based on the amount or quality of underlying data at each satellite. If the weighing factor is applied, the global weight matrix can be computed as follows:

$${W}_{e}^{g} = \frac{1}{S} [ D e c ( {k}_{s e c} , ( {w}^{1} ⊗ {C}_{e}^{1} ) ⊕ ( {w}^{2} ⊗ {C}_{e}^{2} ) ⊕ … ⊕ ( {w}^{k} ⊗ {C}_{e}^{S} ) ) ]$$

Additionally or alternatively, one or more weighing factors for a particular federated epoch can be applied.

Additionally or alternatively to the techniques described above for receiving satellite weight matrices from the satellite sites and using said satellite weight matrices to update the global weight matrix, the system may be configured to receive gradients of satellite weight matrices and to update the global machine learning model based on the received gradients of satellite weight matrices. For example, each satellite site may generate a satellite weight matrix and then determine, at the satellite site, a gradient of the satellite weight matrix. Each satellite site may then send its determined gradient to the central system. The central system may then compute an average (e.g., a weighted average) of the gradients received. The central system may then modify the global weight matrix by adding or subtracting a term including the computed average of the gradients. The added or subtracted term may comprise a product of a learning rate and the computed average of the gradients.

In some embodiments, system 100 can be configured such that the above model training equations can be performed on data stored in a local database at each of a plurality of satellite sites via a variety of storage mechanisms. For example, such storage mechanisms can include, but are not limited to, flat file (e.g., S3 by AWS, Cloud Storage by GCP), relational and non-relational databases, and advanced graph/image-based databases, along with their associated server addresses and flexible developer ergonomics (e.g., an API).

### Model Building

FIG. 1B depicts a method 120 for building a global machine learning model (e.g., a global network model such as the global network model comprising Wₑ^{g} described above) using analytics artifacts as generated at satellite sites, in accordance with some embodiments. In some embodiments, method 120 may be performed at a central authority of a system for federated machine learning, such as central authority 102 of system 100 as described above. According to some embodiments, a user can orchestrate a federated machine learning process by designing a one or more pipelines that include instructions for automating the machine learning model building and model training processes. The infrastructure necessary for pipeline orchestration can include cloud compute infrastructure and/or bare-metal servers. As used herein, the term pipeline may refer to a set of instructions and procedures for processing and exchanging data in order to collectively develop and train a machine learning model.

At block 122, in some embodiments, a central authority can configure a statistics generation pipeline. A statistics generation pipeline can be configured, for example in accordance with one or more system settings and/or user inputs, to include instructions for automatically generating analytics artifacts indicative of raw data stored in a local database at a satellite site and transmitting these analytics artifacts to a central authority. The statistics generation pipeline can generate analytics artifacts (e.g., statistics) using the raw data such that it does not disclose personally identifiable information or raw data. In some embodiments, the instructions included in the statistics generation pipeline can be distributed from the central authority to one or more satellite sites, such that the satellite sites may perform techniques described herein in accordance with the pipeline. The analytics artifacts can be statistics indicative of the raw data. The analytics artifacts can include an unstructured data set.

At block 124, in some embodiments, the central authority can perform data pre-processing on federated analytics artifacts received from one or more of a plurality of satellite sites. Data pre-processing may include normalizing an unstructured data set and applying weighted averaging mechanisms. In some embodiments, data pre-processing can transform the raw unstructured data set into a usable data format from which the central authority can build a central machine learning model. The data pre-processing can be performed via a remote job execution system that communicates a pre-processing configuration from the central authority to the satellite sites which then begins a pre-processing job that fits a pre-processor on the raw data at the satellite site. The preprocessor can also be used to transform the raw data and generate analytics artifacts of the pre-processed data.

At block 126, in some embodiments, the central authority can build a machine learning model using the processed federated analytics artifacts generated at block 124. According to some embodiments, the system can build a machine learning model using conventional machine learning model development framework such as Sagemaker or Cloud ML Engine. In some embodiments, the system may build the machine learning model using a customized development framework that may be configured in accordance with one or more system settings and/or user inputs.

At block 128, in some embodiments, the central authority can configure a training pipeline to include instructions for performing one or more model training operations in accordance with the training pipeline, including by exchanging model information and model update information as described herein. The training pipeline can include instructions for automatically transmitting a machine learning model from the central authority to a plurality of satellite sites, for running the machine learning model on data stored locally at each satellite site, for generating and transmitting local update data from each satellite site to a central authority, and for updating the machine learning model at the central authority in accordance with the updates received from each satellite site. In some embodiments, the training pipeline is configured separately from the statistics generation pipeline, and the training pipeline will not contain instructions for generating analytics artifacts or performing data pre-processing functions. In some embodiments, the training pipeline can be configured using the machine learning model built at block 126 which uses the federated analytics artifacts received from one or more satellite sites at block 124.

In some embodiments, the training pipeline can include specific training parameters. Specific training parameters can include model hyper-parameters, the training environment, and any data pre-processing functions necessary prior to beginning model training. Hyperparameters can include, but are not limited to, loss type, degree of regularization, learning rate, and number of federated epochs and/or satellite epochs a model should be trained for. Data pre-processing functions can include, but are not limited to, data normalization parameters, shuffle type, and training batch size. In some embodiments, the training configuration file can include information that indicates preferred hardware type in order to run a machine learning model training job at a satellite site.

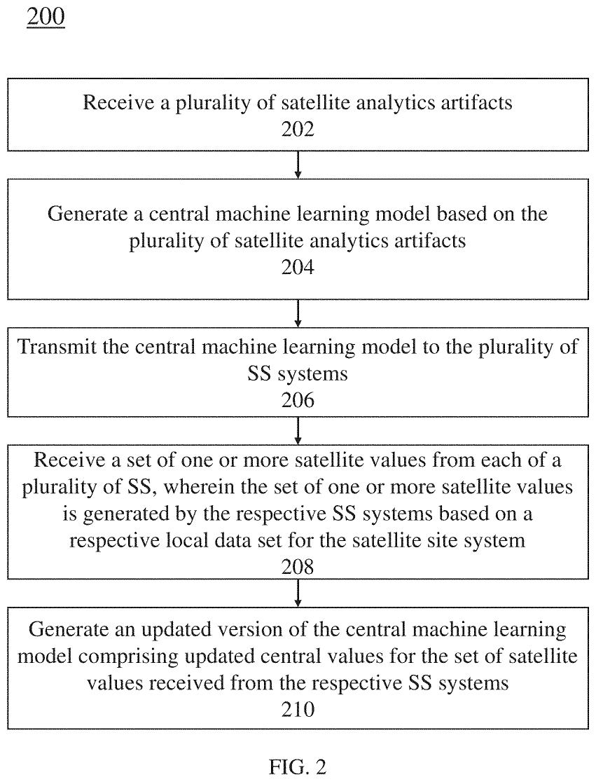

An exemplary procedure for training a machine learning model, for example in accordance with a training pipeline as described herein, is described below with reference to FIG. 2.

### Model Training

FIG. 2 depicts a method 200 for federated machine learning, in accordance with some embodiments. Method 200 is presented from the perspective of a central authority, which may work in conjunction with a plurality of satellite sites (for example according to instructions included in a training pipeline) to execute the method. In some embodiments, method 200 may be performed by a central authority of a system for federated machine learning, such as central authority 102 of system 100 as described above.

At block 202, in some embodiments, the central authority may receive a plurality of satellite analytics artifacts from a plurality of respective satellite systems. The plurality of satellite analytics artifacts may include statistics (e.g., analytics artifacts) and schema information generated from raw data stored at a plurality of satellite sites. The schema information can include information related to the dataset such as column names or data types. The schema information can also be other metadata associated with the raw dataset that can enable a data scientist to build a machine learning model. The statistics generation pipeline can extract useful statistical information about the dataset including but not limited to counts, frequency tables, mean, median, mode, distribution of data, correlation between features for tabular data, image type and meta-data for image datasets, and text sentiment, complexity, etc. for text data.

According to some embodiments, the statistics and schema information may be generated by a satellite site computing device in response to receiving a statistics generation pipeline from a central authority. Each satellite site may receive a statistics generation pipeline from the central authority. In some embodiments, the statistics generation pipeline may be configured to include instructions for each of the satellite sites to automatically generate statistics and schema information, based on a local data set stored at or accessible to the respective satellite site, and to transmit the statistics and schema information to the central authority.

According to some embodiments, statistics and schema information can be generated from raw data stored in a local database by a statistics generation pipeline using a schema extractor and GAN networks. According to some embodiments, the statistics generation pipeline can be configured to include instructions for a computing device at the central authority to execute certain steps upon receiving the statistics and schema information from each satellite site, such as data pre-processing, statistics generation, and data transformation. In one or more embodiments, the statistics computation can be performed at the satellite sites and the analytics artifacts generated from the statistics computation job can be communicated back to the central authority. There may be a check at the satellite site to make sure that no personally identifiable information (PII) leaves the satellite sites.

At block 204, in some embodiments, the central authority can generate a central machine learning model based on a plurality of satellite analytics artifacts received from a plurality of satellite sites. The central learning model can be generated using aggregation algorithms described above. The central learning model can be based on a model architecture. In some embodiments, prior to beginning training of the model, the model architecture may be communicated to the plurality of satellite systems. In some embodiments, a central machine learning model can be developed at the central site based on the statistics and schema information extracted from the satellite sites. There are no limits to the type of model that can be built at the central authority before communication of that model to the satellite sites.

At block 206, in some embodiments, the central authority can transmit the central machine learning model to a plurality of satellite site systems. The device located at a central authority can transmit the central model using a secure communication channel as will be described further below. The central model can also be communicated using one or more cloud-based containerized applications. The cloud-based containerized application can include Kubernetes clusters orchestrated by the device located at the central authority which will orchestrate the jobs to satellite locations.

At block 208, in some embodiments, a device located at a central authority can receive a set of one or more satellite values from each of a plurality of satellite sites. These values may be generated by the respective satellite systems using the model transmitted to the satellite systems and using respective local data sets located at or accessible to the respective satellite system. The set of one or more satellite values, transmitted from the satellite systems back to the central authority, can be included in a satellite weight matrix for each respective satellite site. The satellite weight matrix may be generated in accordance with a round of training of the global model, as performed individually at each of the satellite sites. For example, prior to the training, the central authority can send the central machine learning model to the satellite sites. Each satellite site can then perform a round of training locally using data stored in a local database before sending an updated satellite weight matrix (and/or values for said matrix) back to the central authority, where the satellite weight matrix (and/or values for said matrix) transmitted to the central authority are representative of local updates for that satellite site that are determined in accordance with the round of training. In some embodiments, the local satellite weight matrix (and/or values for said matrix) may be encrypted by homomorphic encryption prior to being sent to the central system.

At block 210, in some embodiments, the central authority can generate an updated version of the central machine learning model that includes central values determined based on the satellite weight matrices (and/or values for said matrices) received from a plurality of satellite sites. In some embodiments, the central authority may make updates to the central machine learning model, based on the received satellite weight matrices (and/or values for said matrices), in accordance with the procedures for updating a central model as set out above.

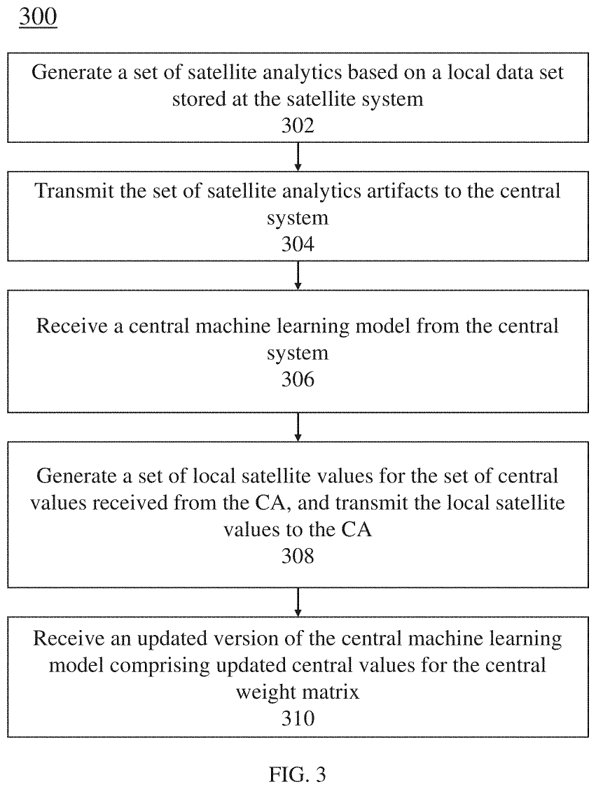

FIG. 3 depicts a method 300 for federated machine learning, in accordance with some embodiments. Method 300 is presented from the perspective of a satellite system, which may work in conjunction with a central authority (for example according to instructions included in a training pipeline) to execute the method. In some embodiments, method 300 may be performed by a satellite system that forms part of a system for federated machine learning, such as satellite system 108 of system 100 as described above.

At block 302, in some embodiments, the satellite site can generate a set of satellite analytics artifacts based on a local data set that is stored at the satellite site. In some embodiments, the satellite site generates the set of satellite analytics artifacts using a satellite site (SS) computing device, such as SS computing device 112 as described above. The plurality of satellite analytics artifacts may include statistics and schema information generated based on data stored at the satellite site. According to some embodiments, the statistics and schema information may be generated by a satellite site computing device, such as SS computing device 112, in accordance with a statistics generation pipeline received from a central authority.

At block 304, in some embodiments, the SS computing device can transmit the set of analytics artifacts generated using data stored in a local database to a central authority. According to some embodiments, the set of analytics artifacts are transmitted to the central authority in accordance with a statistics generation pipeline. In some embodiments, the statistics generation pipeline includes instructions for automatically generating statistics and schema information and for transmitting these statistics and schema information to the central authority.

At block 306, in some embodiments, the SS can receive a central machine learning model from a central authority. The central machine learning model may have been generated by the central authority based on analytics artifacts transmitted to the central authority by a plurality of satellite sites included in the federated learning system. The central machine learning model can include a set of central values in a central (e.g., global) weight matrix that were generated by the central authority based on one or more of the satellite weight matrices (and/or values for said matrices) received from the plurality of satellite sites. In some embodiments, the SS computing device can receive model architecture information such as number of layers, size, shape, and/or type of model relating to the desired machine learning model prior to receiving the central machine learning model. According to some embodiments, the SS computing device can receive a central machine learning model from a central authority in accordance with a training pipeline.

At block 308, in some embodiments, the SS computing device can generate a set of local satellite values for a set of central values in a central weight matrix received (e.g., received as part of the machine learning model or as part of an update to the machine learning model) from the central authority. The satellite values can be generated based on a data set stored locally at the satellite site. The satellite values generated at each respective satellite site can be generated as the result of a round of training of the model performed at the satellite site. For example, the SS computing device may receive a central model from a central authority that includes a set of central values in a central weight matrix, generate a set of local satellite values (and/or a satellite weight matrix that contains those values) that represent a locally trained update to the central weight matrix received from the CA. At block 308, in some embodiments, the local satellite values can be transmitted to the central authority in the form of a satellite weight matrix. In some embodiments, the satellite weight matrix is encrypted by homomorphic encryption prior to being transmitted to the central system.

At block 310, in some embodiments, the SS computing device can receive an updated version of a central machine learning model, which may have been generated by the central authority based on the local satellite values transmitted to the central authority by the satellite system (and based on other local satellite values transmitted to the central authority by other satellite systems). The updated version of the central machine learning model can include updated central values generated based on the locally trained update transmitted to the central authority at block 308.

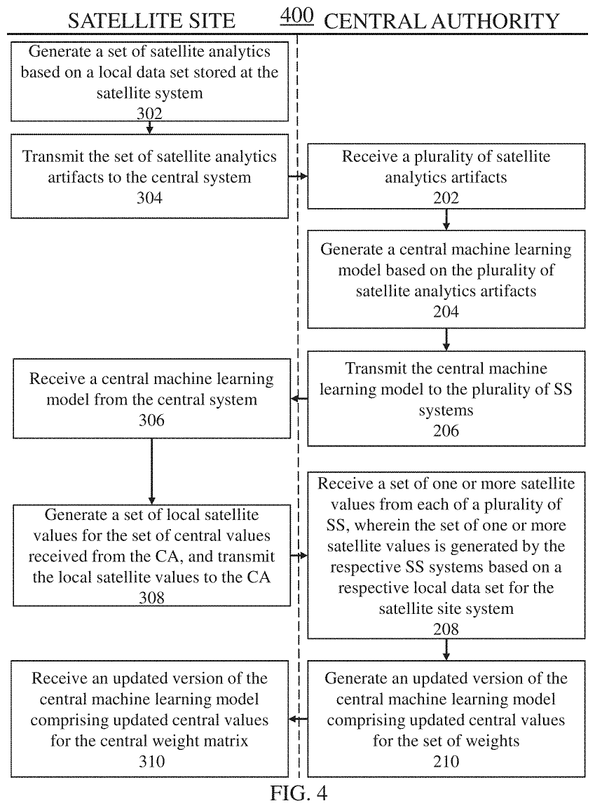

FIG. 4 depicts a method 400 for federated machine learning, in accordance with some embodiments. Method 400 indicates an order in which the steps of method 200 and method 300 may be performed collectively as a combined method for federated machine learning by a system including a central authority and a satellite system (of a plurality of satellite systems). In some embodiments, method 400 may be performed by a system for federated machine learning, such as system 100 as described above.

### Collaborative Model Building System

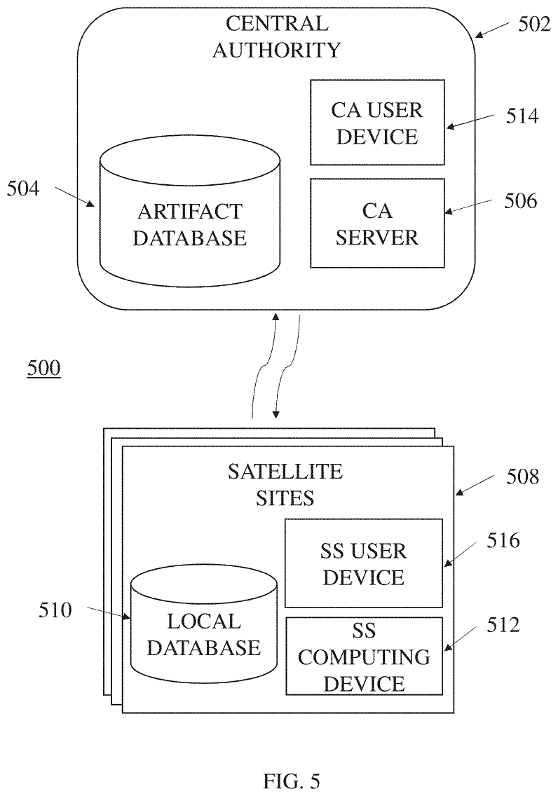

FIG. 5 depicts a system 500 for collaborative federated machine learning, in accordance with some embodiments. In some embodiments, components of system 500 may share any one or more aspects in common with corresponding components of system 100. System 500 may differ from system 100 in that system 500 may include a satellite site (SS) user device 516 at each of one of a plurality of satellite sites for a user at each satellite site to participate in collaboratively building a global machine learning model. System 500 may differ from system 100 in that system 500 may be configured to rely on a user at each satellite site 508 to generate a set of analytics artifacts indicative of raw data stored at the satellite site or accessible from the satellite site and perform data pre-processing functions prior to a user at the central authority 502 using the CA user device 514 to build a central machine learning model based on pre-processed analytics artifacts received from each satellite site 508. In some embodiments, system 500 can be configured to create a central machine learning model by iteratively updating the global model based on aggregated data received from a series of satellite sites according to techniques described above. The central machine learning model can be, for example, a deep neural network, a recurrent neural network, or a convolutional neural network.

As shown in FIG. 5, system 500 may include a central authority 502, which both communicates data to and receives data from various satellite sites 508. Central authority 502 may be configured to communicate (e.g., by one or more wired or wireless network communication protocols and/or interfaces(s)) with the plurality of satellite sites 508 in order to build and train a machine learning model.

Central authority 502 can include a central authority (CA) user device 504. CA user device 504 can include any computerized system configured to communicate with a plurality of satellite sites 508 and to execute one or more processes to build and train a machine learning model in conjunction with said satellite sites 508. CA user device 504 can be operated by a CA data scientist to execute one or more inputs that may be used to control the manner in which central authority 502 generates and/or trains a central machine learning model using input data received from each remote satellite site 508. In some embodiments, the CA data scientist can design custom model architecture for a specific machine learning process. In some embodiments, the CA data scientist can rely on pre-built architecture.

In some embodiments, the CA data scientist can use CA user device 504 to communicate AI model analytics artifacts for a given machine learning model to a plurality of satellite sites before training a given machine learning model.

In some embodiments, the AI model analytics artifacts can include model weight tensors. Model weight tensors can represent parameters obtained after a round of training on data located at satellite devices. In some embodiments, the model weight tensors can be initialized randomly. According to other embodiments where a pre-built model is used, model weight tensors can be imported from the pre-built model.

In some embodiments, the AI model analytics artifacts can include model metadata. Model metadata can include information relating to the state of a given model. For example, model metadata can include the number of epochs a model was trained over, the dataset(s) on which the model was trained, any feature pre-processing steps performed by a user at a satellite site, any training hyperparameters, data versions, and/or performance metrics of the model. The AI model metadata can clearly establish which version of a model (e.g., at which epoch or round of training) certain data represents. Such identifying model metadata can thereby prevent confusion among users in a collaborative model building system. In some embodiments, model metadata for a given machine learning model job can be stored in a centralized database.

In some embodiments, a CA data scientist can use CA user device 504 to conduct training preparation before beginning a given machine learning job. Training preparation can include the CA data scientist developing a training pipeline. The training pipeline can include instructions for performing one or more model training operations in accordance with the training pipeline, including by exchanging model information and model update information as described herein.

The plurality of satellite sites 508 each may include any computerized system configured to communicate with central authority 502 to build and train a machine learning model collaboratively with central authority 502. As shown, a satellite site 508 may include a respective set of one or more processors, such as SS computing device 512. Additionally, a satellite site 508 may include a respective computer storage medium, such as local database 510, configured to store local data usable to train and build learning models as described herein. Satellite site 508 may also include a SS user device 516 operable by a SS user. An SS user may use SS user device 516 in order to execute one or more inputs that may be used to control the manner in which satellite site 508 generates data analytics artifacts and/or trains a machine learning model as described herein. The SS user can, in some embodiments, perform data preparation. Data preparation can include performing statistics generation using data stored in a local database or accessible from the SS user device 516. Data preparation can include, but is not limited to, applying weighted averaging mechanisms, specifying a training batch size, performing functions related to shuffle type, and normalizing an unstructured data set. In some embodiments, data preparation can include generating a set of analytics artifacts based on data stored in a local database or accessible from the SS user device 516.

In FIG. 5, detailed components of one exemplary satellite site 508 are shown, though it should be understood that any one or more of the plurality of satellite sites 508 may include the same or similar corresponding components. In some embodiments, system 500 may be configured such that satellite site 508 can be connected to and disconnected from central authority 502, for example in response to a user instruction or automatically in response to one or more trigger conditions, together with or independently from one or more of the other satellite sites 108.

In some embodiments, satellite sites 508 can be distributed across multiple geographic locations, multiple different organizations, and/or multiple departments within the same organization. In some embodiments, satellite sites may be located geographically proximate to one another (including, even, by being provided as a part of the same computer system) while being communicatively demarcated from one another (e.g., such that they cannot communicate directly with one another). In some embodiments, SS computing device 512 may include a cloud-based and/or bare-metal server.

According to some embodiments, system 500 can be configured to utilize satellite data and statistics generated at a remote satellite location by a user at the satellite site for data preprocessing, feature engineering, machine learning model building, or model averaging. Feature engineering can include building a remote configuration of the required feature engineering at the central authority, which can be communicated to the satellite sites. The remote configuration can be configured to begin a remote feature engineering job at the satellite sites. The remote configuration can include a feature transformer which can be fit to the data at the satellite site before an aggregated feature transformer is communicated back to the central authority. Thereafter, the feature transformer can be sent to a new satellite site to be fit onto a new data set at the new satellite site. The process of communicating the remote configuration to a satellite site, fitting the feature transformer on the local data, and transmitting the aggregated feature transformer to the central authority can be iteratively repeated at all satellite sites. The final transformer, which was fit on data at multiple satellite sites, can be used to transform the data and feed the data into machine learning models.

### Secure Communication Systems

According to some embodiments, system 100 for federated machine learning and system 500 for collaborative federated machine learning can utilize a secure communication system. In some embodiments, the secure communication system can be a virtual private cloud (VPC). The VPC can be deployed by a user at a central authority to a plurality of federated satellite sites. In some embodiments, the VPC can serve as a private, enterprise-specific, cloud environment that enables an organization to build decentralized data applications using each respective organization's sensitive data. The sensitive data for each organization can be stored locally in a secure local database. According to some embodiments, system 100 or system 500 can be configured to include access controls and data management software to preserve ownership and attribution of the data inside the VPC. The VPC can include secure and encrypted peer-to-peer communication channels that only allow model analytics artifacts to be communicated between a given organization and the VPC. According to some embodiments, the communication channels can be configured to be either synchronous or asynchronous, depending on the training procedure being conducted.

In some embodiments, system 100 or system 500 can be configured to include a WebSocket connection protocol. A WebSocket connection protocol can provide full-duplex communication channel abilities over a single transmission control protocol (TCP) connection.

In another embodiment, system 100 or system 500 can be installed on a secured private network at a satellite site. Installation on a secure private network can be accomplished via installing a packaged SDK on the private network. A packaged SDK can be installed via a Docker Image, Make, or a local Pip file. A user at the satellite site can connect the private secure networks to a centralized server within the private network via a gateway. The gateway can act as a centralized communication platform and hold a parameter server and distributed learning pieces.

### Computing Device

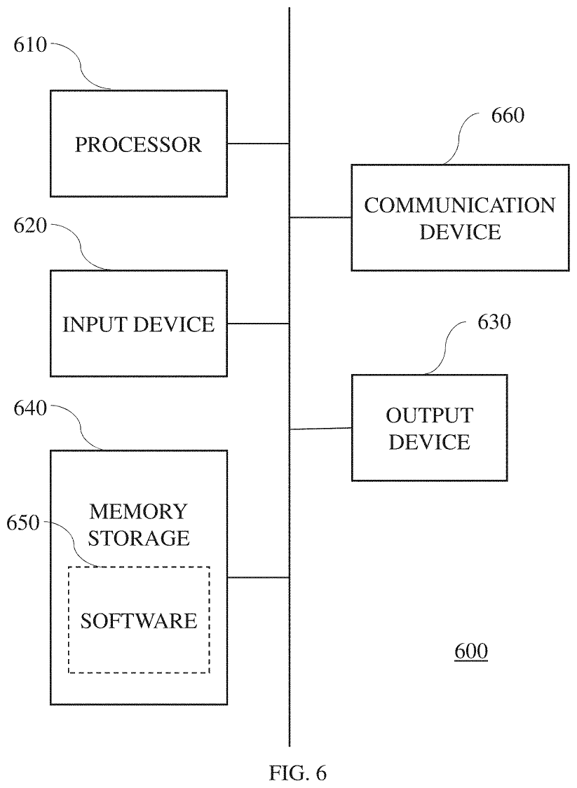

The operations described above, including those described with references to FIGS. 1-5B, are optionally implemented by one or more computing systems having components depicted in FIG. 6. It would be clear to a person having ordinary skill in the art how other processes, for example, combinations or sub-combinations of all or part of the operations described above, may be implemented based on the components depicted in FIG. 6. It would also be clear to a person having ordinary skill in the art how the methods, techniques, and systems described herein may be combined with one another, in whole or in part, whether or not those methods, techniques, systems, and/or devices are implemented by and/or provided by the components depicted in FIG. 6.

FIG. 6 depicts a computing device in accordance with some embodiments. Device 600 can be a host computer connected to a network. Device 600 can be a client computer or a server. As shown in FIG. 6, device 600 can be any suitable type of microprocessor-based device, such as a personal computer, workstation, server or handheld computing device (portable electronic device) such as a phone or tablet. The device can include, for, example, one or more of processor 610, input device 620, output device 630, storage 640, and communication device 660. Input device 620 and output device 330 can generally correspond to those described above, and can either be connectable or integrated with the computer.

Input device 620 can be any suitable device that provides input, such as a touch screen, keyboard or keypad, mouse, or voice-recognition device. Output device 630 can be any suitable device that provides output, such as a touch screen, haptics device, or speaker.

Storage 640 can be any suitable device that provides storage, such as an electrical, magnetic or optical memory including a RAM, cache, hard drive, or removable storage disk. Communication device 660 can include any suitable device capable of transmitting and receiving signals over a network, such as a network interface chip or device. The components of the computer can be connected in any suitable manner, such as via a physical bus or wirelessly.

Software 650, which can be stored in storage 640 and executed by processor 610, can include, for example, the programming that embodies the functionality of the present disclosure (e.g., as embodied in the devices as described above).

Software 650 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 640, that can contain or store programming for use by or in connection with an instruction execution system, apparatus, or device.

Software 650 can also be propagated within any transport medium for use by or in connection with an instruction execution system, apparatus, or device, such as those described above, that can fetch instructions associated with the software from the instruction execution system, apparatus, or device, and execute the instructions. In the context of this disclosure, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

Device 600 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 600 can implement any operating system suitable for operating on the network. Software 650 can be written in any suitable programming language, such as C, C++, Java, or Python. In various embodiments, application software embodying the functionality of the present disclosure can be deployed in different configurations, such as in client/server arrangement or through a Web browser as a Web-based application or Web service, for example.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

1. A computer-implemented method for federated machine learning, the method performed by a central system communicatively coupled to a plurality of satellite site systems, the method comprising:
receiving a plurality of satellite analytics artifacts from respective satellite site systems of the plurality of satellite site systems;
generating a central machine learning model based on one or more of the plurality of satellite analytics artifacts, wherein the central machine learning model comprises a set of central values for a set of weights;
executing a federated machine learning epoch, comprising:
transmitting the central machine learning model to the plurality of satellite site systems;
receiving, at the central authority, from each of the respective satellite site systems, a respective set of one or more satellite values for the set of weights, wherein the set of one or more satellite values is generated by a respective satellite site system based on a respective local dataset of the respective satellite site system; and
generating, based on the satellite values received from the satellite site systems, an updated version of the central machine learning model comprising updated central values for the set of weights.

2. The method of claim 1, wherein generating the updated version of the machine learning model comprises applying an averaging algorithm to the satellite values to generate a weight matrix comprising one or more average values for the set of weights.

3. The method of claim 2, wherein applying the averaging algorithm comprises applying one or more weighing factors for the respective satellite site systems.

4. The method of claim 1, further comprising:
generating a machine learning pipeline based on one or more of the plurality of satellite analytics artifacts; and
transmitting information regarding the machine learning pipeline to the plurality of satellite site systems.

5. The method of claim 4, wherein the machine learning pipeline comprises instructions for performing one or more of: a data preprocessing function, a statistics generation process, a data transformation process, a feature engineering process, a model training process, a model evaluation process, and a model storing process.

6. The method of claim 1, wherein the one or more satellite values is generated by the respective satellite site system by applying an optimization operation.

7. The method of claim 1, wherein the one or more satellite values are encrypted using a homomorphic scheme before transmission from the respective satellite site systems to the central authority.

8. The method of claim 1, wherein the plurality of satellite analytics artifacts comprise statistics and schema artifacts for each of the plurality of satellite site systems which are generated by a statistics generation pipeline.

9. The method of claim 1, wherein the respective satellite values are received as part of respective model artifacts received from each of the respective satellite site systems.

10. The method of claim 1, further comprising one or more of:
deploying the updated version of the central machine learning model to one or more selected from: one or more of the plurality of satellite site systems, a computer storage medium associated with the central authority, and an external system.

11. A computing system for federated machine learning comprising:
a central system communicatively coupled to a plurality of satellite site systems; and
one or more processors coupled to one or more memory devices, wherein the one or more memory devices include instructions which when executed by the one or more processors cause the system to:
receive a plurality of satellite analytics artifacts from respective satellite site systems of the plurality of satellite site systems;
generate a central machine learning model based on one or more of the plurality of satellite analytics artifacts, wherein the central machine learning model comprises a set of central values for a set of weights;
execute a federated machine learning epoch, comprising:
transmitting the central machine learning model to the plurality of satellite site systems;
receiving, at the central authority, from each of the respective satellite site systems, a respective set of one or more satellite values for the set of weights, wherein the set of one or more satellite values is generated by a respective satellite site system based on a respective local dataset of the respective satellite site system; and
generating, based on the satellite values received from the satellite site systems, an updated version of the central machine learning model comprising updated central values for the set of weights.

12. A computer-readable medium that stores instructions that, when executed by a computing device, cause the device to:
receive a plurality of satellite analytics artifacts from respective satellite site systems of the plurality of satellite site systems;
generate a central machine learning model based on one or more of the plurality of satellite analytics artifacts, wherein the central machine learning model comprises a set of central values for a set of weights;
execute a federated machine learning epoch, comprising:
transmitting the central machine learning model to the plurality of satellite site systems;
receiving, at the central authority, from each of the respective satellite site systems, a respective set of one or more satellite values for the set of weights, wherein the set of one or more satellite values is generated by a respective satellite site system based on a respective local dataset of the respective satellite site system; and
generating, based on the satellite values received from the satellite site systems, an updated version of the central machine learning model comprising updated central values for the set of weights.

13. A computer-implemented method for federated machine learning, the method performed by a satellite site system communicatively coupled to a central system communicatively coupled to a plurality of respective satellite site systems, the method comprising:
generating a set of satellite analytics artifacts based on a local data set stored at the satellite site system;
transmitting the set of satellite analytics artifacts to the central system;
receiving, from the central system, a central machine learning model, wherein the central machine learning model is generated based at least in part on the satellite analytics artifacts and wherein the central machine learning model comprises a set of central values for a set of weights;
generating a set of satellite values for the set of weights, wherein the set of satellite values is generated based on the local data set;
transmitting the set of satellite values to the central system;
receiving, from the central system, an updated version of the central machine learning model comprising updated central values for the set of weights, wherein the updated version of the central machine learning model is generated by the central system at least in part based on the set of satellite values.

14. The method of claim 13, wherein generating the set of satellite analytics artifacts comprises extracting a set of schema and statistics from the local data set using a statistics generation pipeline that is transmitted to the plurality of satellite sites and is configured to compute the schema and statistics from the local data set and communicate the extracted schema and statistics to the central authority.

15. The method of claim 13, wherein generating the set of satellite values comprises applying a stochastic gradient descent.

16. The method of claim 13, wherein generating the set of satellite values comprises applying ADAM optimization.

17. The method of claim 13, wherein transmitting the set of satellite analytics artifacts to the central system comprises:
applying a homomorphic encryption scheme to encrypt the satellite analytics artifacts; and
transmitting the satellite analytics artifacts in encrypted form.

18. The method of claim 13, wherein transmitting the set of satellite values to the central system comprises:
applying a homomorphic encryption scheme to encrypt the satellite values; and
transmitting the satellite values in encrypted form.

19. A computing system for federated machine learning comprising:
a satellite site system communicatively coupled to a central system communicatively coupled to a plurality of respective satellite site systems; and
one or more processors coupled to one or more memory devices, wherein the one or more memory devices include instructions which when executed by the one or more processors cause the system to:
generate a set of satellite analytics artifacts based on a local data set stored at the satellite site system;
transmit the set of satellite analytics artifacts to the central system;
receive, from the central system, a central machine learning model, wherein the central machine learning model is generated based at least in part on the satellite analytics artifacts and wherein the central machine learning model comprises a set of central values for a set of weights;
generate a set of satellite values for the set of weights, wherein the set of satellite values is generated based on the local data set;
transmit the set of satellite values to the central system;
receive, from the central system, an updated version of the central machine learning model comprising updated central values for the set of weights, wherein the updated version of the central machine learning model is generated by the central system at least in part based on the set of satellite values.

20. A computer-readable medium that stores instructions that, when executed by a computing device, cause the device to:
generate a set of satellite analytics artifacts based on a local data set stored at the satellite site system;
transmit the set of satellite analytics artifacts to the central system;
receive, from the central system, a central machine learning model, wherein the central machine learning model is generated based at least in part on the satellite analytics artifacts and wherein the central machine learning model comprises a set of central values for a set of weights;
generate a set of satellite values for the set of weights, wherein the set of satellite values is generated based on the local data set;
transmit the set of satellite values to the central system;
receive, from the central system, an updated version of the central machine learning model comprising updated central values for the set of weights, wherein the updated version of the central machine learning model is generated by the central system at least in part based on the set of satellite values.
